(19) United States
(12) Patent Application Publication
(10) Pub. No.: US 2013/0135879 A1
(43) Pub. Date: May 30, 2013

(54) THERMALLY ISOLATED HEAT SINK FOR LED LIGHTING

(71) Applicant: SCOTT A. RIESEBOSCH, St. Catharines (CA)

(72) Inventor: SCOTT A. RIESEBOSCH, St. Catharines (CA)

(73) Assignee: CRS Electronics, Welland (CA)

(21) Appl. No.: 13/305,959

(22) Filed: Nov. 29, 2011

(51) Int. Cl. F21V 29/00

(52) U.S. Cl. 362/382

(57) ABSTRACT

A system for protecting a heat-sensitive component in an LED lamp from overheating. The system including: a heat-generating component, a heat-dissipating component thermally coupled to the heat-generating component, a heat-sensitive component electrically connected to the heat-generating component, and a heat-isolating element for thermally isolating the heat-generating component and the heat-sensitive component.

### FIELD OF THE INVENTION

In various embodiments, the present invention relates, in general, to light-emitting diode (LED) systems and, more specifically, to systems and methods for preventing heat-sensitive components in an LED lamp from overheating.

### BACKGROUND

LED-based lamps are an attractive alternative to incandescent lamps due to their smaller form factor, lower energy consumption, longer operational lifetime, and/or enhanced mechanical robustness. LED lamps also generate less waste heat than incandescent lamps; this heat, however, still must be disposed of safely. In contrast to incandescent light sources, which radiate most of their waste heat as infrared light, LEDs do not radiate a significant portion of energy—as heat or otherwise—outside of the emission spectrum. Instead, most waste heat generated by LED lamps is conducted away via thermal transmission. Electronic components in LED lamps may have different sensitivities to the heat; some components may preferably be operated at a relatively low temperature to extend their lifetime. For example, electrolytic capacitors that perform various functions (e.g., filtering noise) in LED lamps are highly sensitive to elevated temperatures; a lifetime of more than 100,000 hours may be achieved by operating the LED at 65° C., while the lifetime drops to approximately 7,000 hours when the operating temperature is at 100° C. Lifetime of these temperature-susceptible components may thus limit the life of the whole LED lamp.

Conventionally, a heat sink may be used in LED lamps to dissipate heat generated by various active electronic components (i.e., heat-generating components). The heat sink, however, is shared among all electronic components, including the heat-generating components and other, heat-sensitive components. Heat generated by the active electronic components may be transferred to the heat-sensitive components (e.g., electrolytic capacitors) via the heat sink, via other thermally-conductive components in the LED lamp and/or through air convection and radiation. The transferred heat thus raises the temperature at which the heat-sensitive components operate inside of LED lamps and may result in degradation or failure of LED lamps due to the overheated components. Consequently, there is a need for extending the lifetime of LED lamps by preventing or reducing heat transfer from the heat-generating components to the heat-sensitive components.

### SUMMARY

In various embodiments, the present invention relates to systems and methods for preventing or reducing heat transfer from heat-generating components in an LED lamp to one or more heat-sensitive components in the LED lamp by using a heat-isolating design or component. The heat-isolating design or component may be implemented on the surface of the LED lamp or inside the LED lamp; it confines heat generated by a first component within a space or area that is thermally isolated from one or more other, heat-sensitive components. In one embodiment, the generated heat is dissipated using a heat-dissipating component (e.g., a heat sink, a housing or other structural component of the LED lamp and/or air). Additionally, a second heat-dissipating component, separate from the first heat-dissipating component, may be thermally connected to the heat-sensitive component(s). The second heat-dissipating component may manage the temperature of the heat-sensitive component(s) to thereby extend their operating lifetime. This approach thus prevents the heat-sensitive component from overheating, thereby optimizing the performance and improving the lifetime of the LED lamps.

Accordingly, in one aspect, the invention pertains to a system for protecting a heat-sensitive component in an LED lamp from overheating. The system includes: a heat-generating component, a heat-dissipating component thermally coupled to the heat-generating component, a heat-sensitive component electrically connected to the heat-generating component, and a heat-isolating element for thermally isolating the heat-generating component and the heat-sensitive component. In one implementation, the heat-sensitive component is an electrolytic capacitor or a control IC. In another implementation, the heat-generating component is an LED or a driver IC.

In various embodiments, the heat-isolating element is a spatial gap between the heat-generating component and the heat-sensitive component, and the heat-generating component and the heat-sensitive component are not thermally coupled by a common heat sink. In one implementation, the heat-isolating element is a material made of at least one of ceramic, plastic or fiberglass.

In some embodiments, the heat-dissipating component is a first heat-dissipating component and further including a second heat-dissipating component thermally connected to the heat-sensitive component but thermally isolated from the first heat-dissipating component. In one embodiment, the second heat-dissipating component is a heat sink. In another embodiment, the first and second heat-dissipating components are separate regions of a single heat-sink structure separated by a second heat-isolating element. In one implementation, the second heat-isolating element is a spatial gap between the first and second heat-dissipating components. In another implementation, the second heat-isolating element is a material made of at least one of ceramic, plastic or fiberglass.

In various embodiments, the second heat-dissipating component has fins exposed to ambient. In one embodiment, the second heat-dissipating component is a vent. In another embodiment, the second heat-dissipating component encompasses a surface of the LED lamp.

In a second aspect, the invention relates to a method for preventing a heat-sensitive electronic component in an LED lamp from overheating. The method includes: dissipating heat from a heat-generating electronic component and preventing heat emitted by the heat-generating electronic component from affecting dissipation of heat from the heat-sensitive electronic component. In some embodiments, the method further includes dissipating heat from the heat-sensitive electronic component.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The term “substantially” means ±10% (e.g., by weight or by volume), and in some embodiments, ±5%. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 schematically illustrates the transfer of heat from a heat-generating component to a heat-sensitive component via a shared heat sink or a structural component in a prior-art configuration;

FIG. 2 schematically depicts the heat-sensitive component thermally isolated from the heat-generating component using a heat-isolating design or component; and

FIG. 3 schematically depicts a second heat-dissipating component attached to the heat-sensitive component for regulating the temperature thereof.

### DETAILED DESCRIPTION

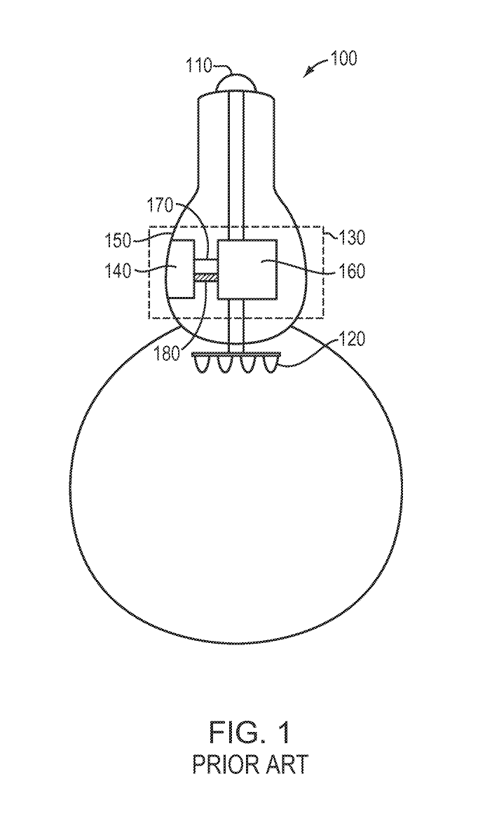

FIG. 1 illustrates a conventional LED lamp 100 in which power provided through a connection base 110 is first converted to an appropriate voltage/current before being applied to LEDs 120 via LED supply circuitry 130. The power may be provided by any appropriate power source, such as an AC mains supply, other AC supply, or DC supply, and the connection base 110 may be adapted for use with a standard light-bulb socket, fluorescent socket, or any other type of connector. The supply circuitry 130 may include any circuitry for powering LEDs in the lamp 100, including power integrated circuits (ICs), control ICs, electronic or magnetic transformers, filters, dimmer control circuits, current or voltage supplies or regulators, or any other circuitry or component known in the art.

In particular, the supply circuitry 130 may include a heat-sensitive electronic component 140 that is susceptible to high temperatures during operation of the LED lamp 100; for example, the component 140 may be an electrolytic capacitor or a control IC, or any other component adversely affected by elevated temperatures. The heat-sensitive component 140 may be thermally connected to a heat-dissipating component 150 (e.g., a housing of the LED lamp, as shown in FIG. 1, or a heat sink) for venting heat generated by an active electronic component 160 in the LED lamp 100. The heat-sensitive component 140 and heat-generating component 160 may be electrically directly or indirectly connected via a component or circuit 170, and the heat-dissipating component 150 may be shared between the heat-generating component 160 and the heat-sensitive component 140 (which may also generate heat). Heat generated by the active electronic component 160 may then be transferred to the heat-sensitive component 140 through the heat-dissipating component 150 or through any other structural component 180—e.g., a housing of the LED lamp, a heat sink, a system board, or even air if the components 140, 150 are too close—that thermally connects the active heat-generating component 160 and heat-sensitive component 140 in the LED lamp 100. As a result, the heat-sensitive component 140 may be the first component in the LED lamp 100 to fail due to the increased temperature.

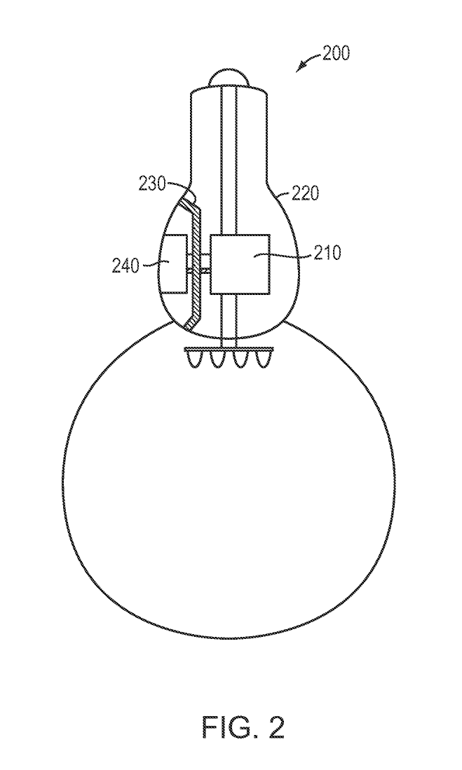

A representative implementation of the invention is shown in FIG. 2. In the illustrated embodiment, the active heat-generating component 210 dissipates heat via a heat-dissipating component 220, for example, a housing of the LED lamp or a heat sink. A heat-isolating element 230 is thermally (e.g., mechanically) coupled to the heat-sensitive component 240, isolating it from the heat generating component 210. This prevents heat generated by the active electronic component 210 from being conducted to the heat-sensitive component 240 via the heat-dissipating component 220 while still permitting the heat-sensitive component 240 to dissipate heat via the thermally isolated portion of the heat-dissipating component 220.

As noted above, the heat-sensitive component 240 may be an electrolytic capacitor, a control IC, or other component whose operating condition is sensitive to the temperature. In some embodiments, the heat-generating component 210 is an LED, a driver IC, or other component that generates heat during LED operation. The heat-isolating element may take various forms. In one embodiment, the heat-isolating element 230 is simply a spatial (air) gap between the heat-generating component 210 and the heat-sensitive component 240. In another embodiment, the heat-isolating element 230 is an evacuated (vacuum) space. In various other embodiments, the heat-isolating component 230 is a thermally isolating (insulating) material such as ceramic, a polymer (e.g., polyurethane foam or other plastic foam), a plastic such as polystyrene, rubber, perlite, or fiberglass.

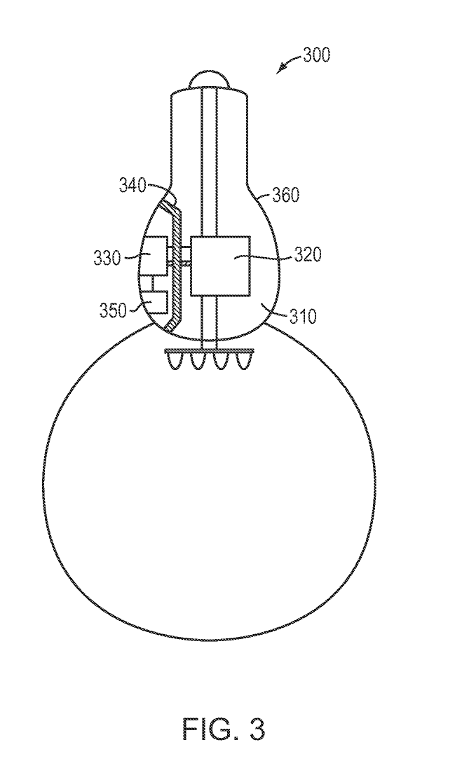

With reference to FIG. 3, because the LED supply circuitry, including the heat-generating component and the heat-sensitive component, are confined within a limited space 310, heat generated from the active electronic component 320 may transfer heat to the heat-sensitive component 330 via conduction, convection, or radiation even in the presence of the heat-isolating element 340. In some embodiments, therefore, a second heat-dissipating component 350 is thermally (e.g., mechanically) coupled to the heat-sensitive component 330. In one embodiment, the second heat-dissipating component 350 is a secondary heat sink. In another embodiment, the second heat-dissipating component 350 is a vent to the ambient, or has surfaces exposed to the ambient that are incorporated into the housing 360 of the LED lamp. The second heat-dissipating component 350, however, is thermally isolated from the main heat-dissipating component, i.e., in FIG. 3, the housing 360 of the LED lamp or a heat sink, which is thermally coupled to the heat-generating component 320. Once again the thermally isolating element 340 may be a spatial (air) gap, an evacuated (vacuum) space, a material filled with air or a material made of, for example, ceramic, a polymer (e.g., polyurethane foam or other plastic foam, a plastic such as polystyrene, rubber, perlite, or fiberglass. In one embodiment, the second heat-dissipating component 350 encompasses the surface of the LED lamp to efficiently dissipate the heat and provide a decorative feature or aesthetic design.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A system for protecting a heat-sensitive component in an LED lamp from overheating, the system comprising:
a heat-generating component;
a heat-dissipating component thermally coupled to the heat-generating component;
a heat-sensitive component electrically connected to the heat-generating component; and
a heat-isolating element for thermally isolating the heat-generating component and the heat-sensitive component.

2. The system of claim 1, wherein the heat-sensitive component is an electrolytic capacitor or a control IC.

3. The system of claim 1, wherein the heat-generating component is an LED or a driver IC.

4. The system of claim 1, wherein (i) the heat-isolating element is a spatial gap between the heat-generating component and the heat-sensitive component, and (ii) the heat-generating component and the heat-sensitive component are not thermally coupled by a common heat sink.

5. The system of claim 1, wherein the heat-isolating element is a material made of at least one of ceramic, plastic or fiberglass.

6. The system of claim 1, wherein the heat-dissipating component is a first heat-dissipating component and further comprising a second heat-dissipating component thermally connected to the heat-sensitive component but thermally isolated from the first heat-dissipating component.

7. The system of claim 6, wherein the second heat-dissipating component is a heat sink.

8. The system of claim 6, wherein the first and second heat-dissipating components are separate regions of a single heat-sink structure separated by a second heat-isolating element.

9. The system of claim 8, wherein the second heat-isolating element is a spatial gap between the first and second heat-dissipating components.

10. The system of claim 8, wherein the second heat-isolating element is a material made of at least one of ceramic, plastic or fiberglass.

11. The system of claim 6, wherein the second heat-dissipating component has fins exposed to ambient.

12. The system of claim 6, wherein the second heat-dissipating component is a vent.

13. The system of claim 6, wherein the second heat-dissipating component encompasses a surface of the LED lamp.

14. A method for preventing a heat-sensitive electronic component in an LED lamp from overheating, the method comprising:
dissipating heat from a heat-generating electronic component; and
preventing heat emitted by the heat-generating electronic component from affecting dissipation of heat from the heat-sensitive electronic component.

15. The method of claim 14, further comprising dissipating heat from the heat-sensitive electronic component.
